(19) United States
(12) Patent Application Publication
(10) Pub. No.: US 2014/0257930 A1
(43) Pub. Date: Sep. 11, 2014

(54) EVALUATING TASTE PROXIMITY FROM A CLOSED LIST OF CHOICES

(71) Applicant: Tastepals Ltd., Yahud (IL)

(72) Inventor: Daniel LEHMANN, Jerusalem (IL)

(73) Assignee: Tastepals Ltd., Yahud (IL)

(21) Appl. No.: 14/202,093

(22) Filed: Mar. 10, 2014

Related U.S. Application Data
(60) Provisional application No. 61/775,606, filed on Mar. 10, 2013.

(51) Int. Cl. G06Q 30/02

(52) U.S. Cl. CPC G06Q 30/0203
USPC 705/7.32

(57) ABSTRACT

A system and method for estimating preferences or taste of users comprises a catalog having a closed number of items; a memory for storing distances between ratings of each pair of items; and a user interface to rate a subset of the items. The distances from the subset items to other items of the catalog give the user a preference for each item in the catalog despite never having rated these items. The catalog is ordered using the assigned preferences into a user preference vector, and is compared with vectors of other users to match up different users having similar preferences. Alternatively a distance measure can be defined between preferences of different users, with matching made between the users having the smallest difference. Initial distances may come from rating by a focus group or from application download data or other suitable sources.

### RELATED APPLICATION

This application claims the benefit of priority under 35 USC §119(e) of U.S. Provisional Patent Application No. 61/775,606 filed Mar. 10, 2013, the contents of which are incorporated herein by reference in their entirety.

### FIELD AND BACKGROUND OF THE INVENTION

The present invention, in some embodiments thereof, relates to a device, system and method for evaluating proximity in preference or taste between individuals based on a closed list of choices, and, more particularly, but not exclusively, to a networked system evaluating taste in this way and/or making use of the results.

A person's taste is defined by what he likes and dislikes. Taste is a highly personal feature related to deep layers of the personality, such as values, emotions and commitments. Often we are able to say whether two persons have similar tastes, or have very different tastes.

In the art, the proximity in taste of two persons can be measured by requiring each of them to rate all items in a predefined catalog and using some measure of distance (or similarity) between the two vectors of ratings.

The astounding popularity of chat rooms over the internet is a witness to the strength of the force driving people to other people. We love interacting with other humans, even, and perhaps especially, through sophisticated technological means. For many, in particular young people, communicating by means of two computer screens, or two smartphones, and the internet is more natural and less intimidating than face-to-face encounters. In the pre-internet age, one could essentially only communicate face-to-face, with persons one already knew (by letters or by phone) or with people recommended by a common acquaintance. Nowadays, the number of people one could possibly be in touch with has exploded by many orders of magnitude.

What does the internet currently provide in terms of increased and enhanced human communication? Essentially two ways are proposed towards forging new meaningful human links. First, innumerable web sites gather information and people around specific topics. People interested in, say, Parkinson's disease, Madonna or U.S. politics will visit web sites devoted to those subjects where they will be able to get to know other visitors, also interested in the same subject. These sites provide both information and communication driven by common interests often with remarkable success, but the relations among people sharing the same narrow interest often stay limited. Secondly, most social networks, where you start with friends you knew before, offer you to expand your circle by getting in touch with the friends of your friends. Here, glancing at their profile should enable you to decide whether you want to know those friends of friends better. Some sites, hunch.com being a prime example, use machine learning algorithms on big data to primarily recommend items and secondarily connect users.

Could one take advantage of the opportunities offered by the internet to enhance one's human relations in further ways? We consider the following two possibilities:
improve the quality of those relations by relating to persons who are better suited than those in your physical environment or the friends of your friends, or
improve the quantity of those relations. Since time is a strong limitation here, taking advantage of a large number of human relations must take the path of automatic data aggregation from a large number of special persons.

In both those endeavors, the key is the ability to find the right, special persons with whom one wants to communicate or from whom one wants to gather information. Those are people with whom we have deep affinities, who like the things we do and whose taste is similar to ours: those strangers who are close to us in taste.

U.S. Pat. Nos. 7,075,000 and 7,102,067, the contents of which are hereby incorporated by reference, relate to a method of determining musical preferences of individual users in order to recommend additional items of music. These patents however do not identify different users with similar tastes, that is they do not identify the close strangers.

### SUMMARY OF THE INVENTION

The present embodiments describe a method to find those close strangers, that is adapted to an internet environment and can be implemented both on computers and mobile devices such as smartphones and tablets.

The present proposal describes a way of evaluating the proximity of taste between two persons without requiring them to rate the same items. It therefore presents a practical way of discovering persons who are close in taste but have never interacted with the same objects before. It then describes a number of possible different ways in which such persons close in taste can profitably interact and what can be done once one knows the personal taste of a large group of persons.

According to an aspect of some embodiments of the present invention there is provided a system for estimating preferences of users implemented using a plurality of electronic processors connected over a network, the system comprising:

a catalog having a closed number of items;

a memory for storing distances between ratings of each pair of the items;

a user interface configured to provide a first user over the network with a subset of the closed number of items, and to obtain ratings from the user for the subset;

one of the processors configured to use respective stored distances from the subset to other items of the catalog to assign to the first user a preference for items of the catalog other than those belonging to the subset; and

the system further configured to use the assigned preferences for the first user to therewith associate the first user with other users having similar preferences by finding ones of the other users whose respective assigned preferences are close to the assigned preferences of the first user.

In an embodiment, for each of the users, the items in the catalog are ordered according to the assigned preferences into a vector.

In an embodiment, the assigned user preference for any one of the items not in the subset comprises a proportional contribution from each one of the subset of items.

In an embodiment, the catalog items are rated by a first plurality of individuals, and the distances comprise an average of distances between ratings provided by each one of the first plurality of individuals.

An embodiment may compare respective vectors based on a number of common items appearing in top M items of the respective vectors, wherein M is a predetermined number.

An embodiment may send to the respective user, profile information of the others users associated by similar preferences.

In an embodiment, the ratings are numerical and the distances comprise a numerical difference between the numerical ratings of respective pairs of items.

An embodiment may add an item to the catalog, the item being added along with ratings so that distances are computable to each other item in the catalog, a preference to each user thereby being obtainable.

In an embodiment, the distances between each pair of items are stored in a matrix, the matrix being quadratic to a size of the catalog.

In an embodiment, the first plurality lies between 32 and 70.

In an embodiment, the items are downloadable device applications and the distances are obtained from data of applications held simultaneously by individual devices.

According to a second aspect of the present invention there is provided a method for estimating preferences of users implemented using a plurality of electronic processors connected over a network, the method comprising:

providing a catalog having a closed number of items;

storing distances between ratings of each pair of items;

providing a user over the network with a subset of the closed number of items;

obtaining ratings from the user for the subset;

using respective stored distances from the subset to other items of the catalog to assign to the user a preference for items of the catalog other than those belonging to the subset; and

using the assigned preferences for a respective user to order all items in the catalog to form a vector for the user, therewith to associate the user with other users having similar preferences by finding other users having similar vectors.

According to a third aspect of the present invention there is provided a method for estimating preferences of users implemented using a plurality of electronic processors connected over a network, the method comprising:

providing a catalog having a closed number of items;

storing distances between ratings of each pair of items;

providing a first user over the network with a subset of the closed number of items;

obtaining ratings from the first user for the subset;

using respective stored distances from the subset to other items of the catalog to assign to the first user a preference for items of the catalog other than those belonging to the subset;

finding a distance using a distance measure between preferences of the first user over the catalog and preferences of a second user; and

associating the user with the second user if the distance is relatively small.

The distance measure used may be a Euclidean distance or any other suitable distance score.

According to a fourth aspect of the present invention there is provided a user client which is placed on an end user device such as a mobile telephone or a computer, and which interacts with the catalog to allow the end user to rate a subset of items in the catalog. The user client provides the ratings to a server to allow the server to calculate the user's preferences within the catalog and then receives recommendations as regarding other users with similar tastes.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified block diagram showing a system for estimating user preferences according to an embodiment of the present invention;

FIG. 2 is a simplified diagram schematically illustrating distances between pairs of items in a catalog according to embodiments of the present invention;

FIG. 3 is a simplified diagram showing a matrix of distance values between pairs of items according to embodiments of the present invention;

FIG. 4 is a simplified diagram showing an interface asking an end user to rate items using stars, according to an embodiment of the present invention;

FIG. 5 is a simplified diagram showing top parts of three vectors ordering the catalog according to the preferences of three different users and showing that users a) and c) have very similar tastes, according to embodiments of the present invention; and

FIG. 6 is a simplified flow chart showing a procedure according to an embodiment of the present invention for finding users having similar preferences.

### DESCRIPTION OF SPECIFIC EMBODIMENTS OF THE INVENTION

The present invention, in some embodiments thereof, relates to a device, system and method for evaluating proximity in preference or taste between individuals based on a closed list of choices, and, more particularly, but not exclusively, to a networked system evaluating taste in this way and then using the results to identify different users having similar tastes.

In the prior art, end users make choices from an open list, or even from a closed list, and are given items or products as suggestions. The present embodiments use the preferences in order to associate between different users. Thus networks of end users may be encouraged based on interest, to add an extra dimension to the social networking known today where new connections are made based on existing connections or finding people in groups. With the present embodiments connections can be made with total strangers in the expectation of having something worthwhile to share with each other.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

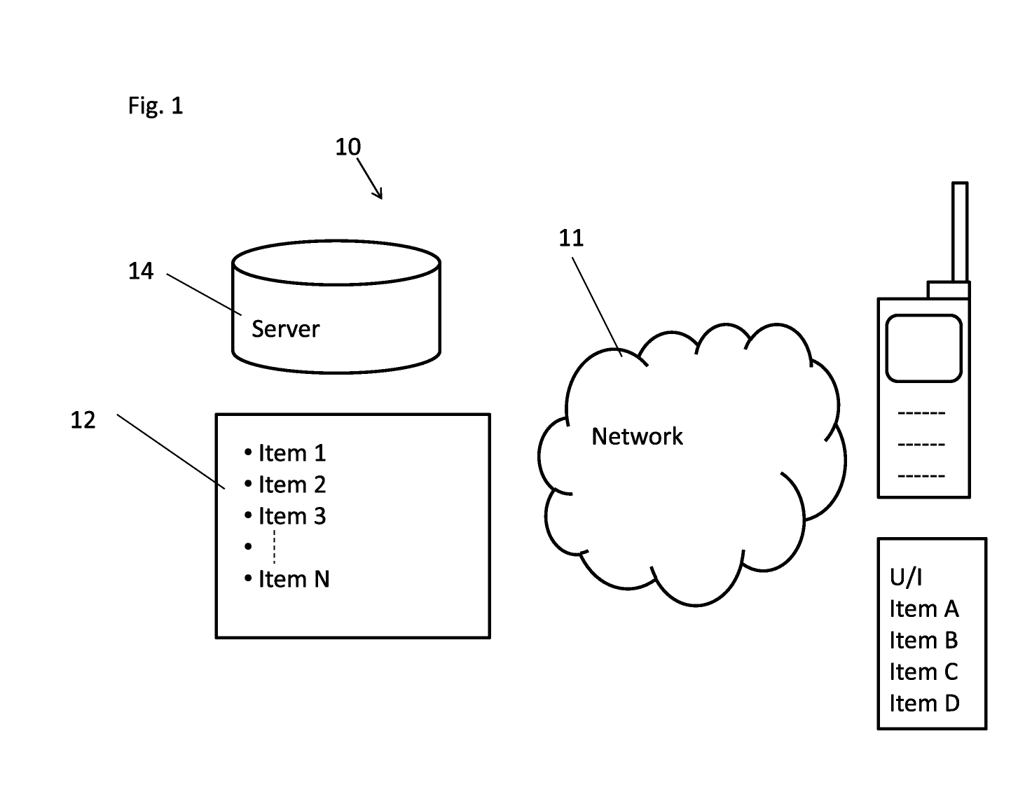

Referring now to the drawings, FIG. 1 is a simplified block diagram of a system according to an embodiment of the present invention for estimating preferences or taste of individual users. The system may be implemented using electronic processors connected over an electronic network 11 such as the Internet or the cellular or conventional telephone system.

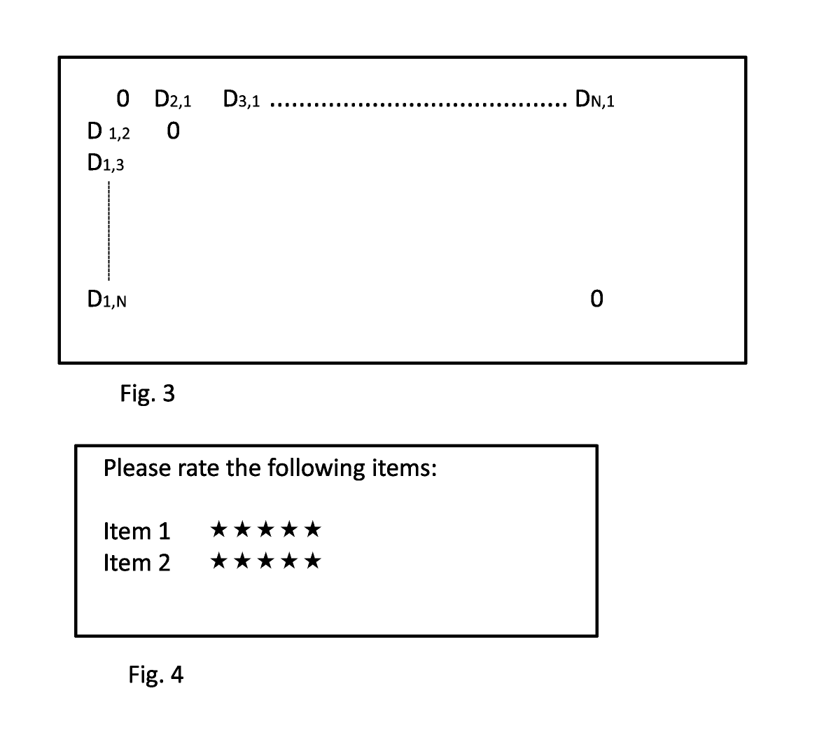

The system 10 includes a catalog 12 having a closed number of items, Item 1 . . . Item N, where N is a positive natural number. The items may all belong to a particular theme or may belong to a wide range of different themes and interests. The catalog is typically hosted in a server 14, and the server may have a memory, shown and discussed below in respect of FIG. 3, for storing distances between ratings of each pair of items in the catalog. As will be discussed in greater detail below there are a number of ways in which ratings may be obtained for the catalog items and a number of ways in which those ratings may be used to calculate distances between the items.

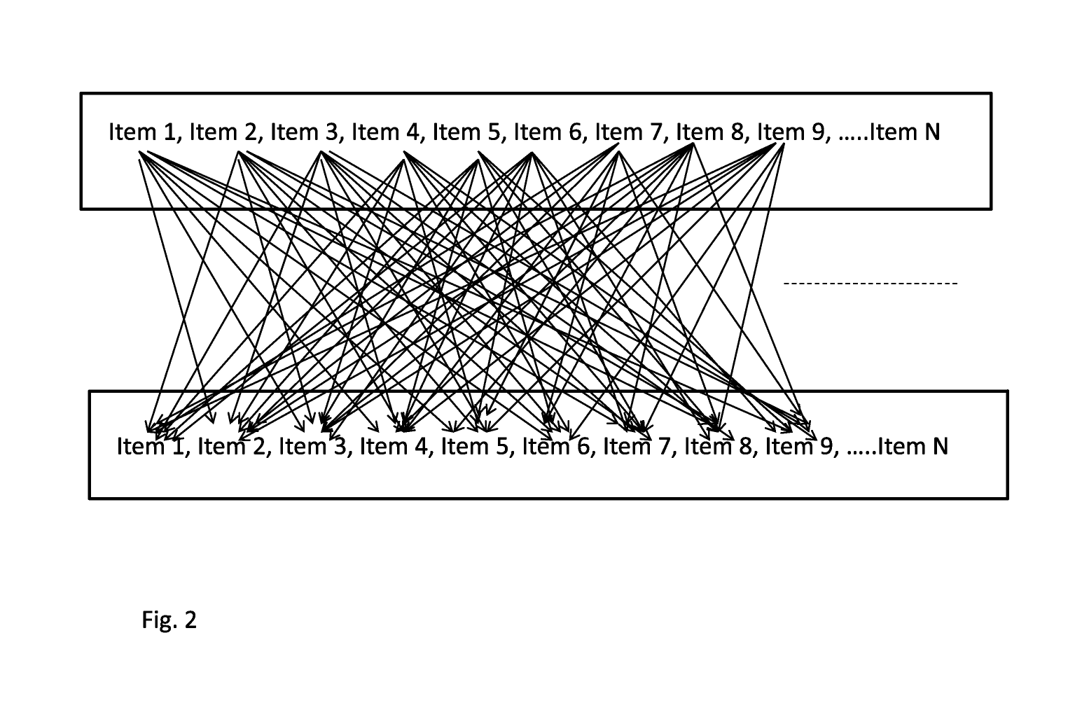

Reference is now made to FIG. 2 which illustrates an N—item catalog and schematically shows distances between each pair of items as arrows. In general, two items with a short distance between them are generally liked by the same people. Two items with a large distance between them tend to be liked by different people.

Once the catalog is rated and distances are obtained between the items, the tastes or preferences of the end user may be estimated. Returning now to FIG. 1, and the end user, who may connect over network 11 via a computer or via a mobile telephone 16 or over any other computing device, is provided with a user interface 18. The user interface provides the end-user with a small subset of the catalog to rate. The end user is not required to rate the entire catalog but only a small number of items, shown in FIG. 1 as four items.

Reference is now made to FIG. 4, which is a simplified diagram showing how the user interface 18 may present items to the end user for rating. The end user sees the items in the interface and rates the items, for example by assigning to the item a number of stars.

Once the user's ratings are received, the ratings may then be used with the stored distances from the user-rated subset to other items of the catalog. Thus each item in the catalog can be provided with an estimated user preference even though the user has not rated that individual item.

In one embodiment, if the end-user rates four items, then there are four distances from rated items to each unrated item in the catalog. These four distances can be averaged or normalized to estimate the user's preference for the unrated item.

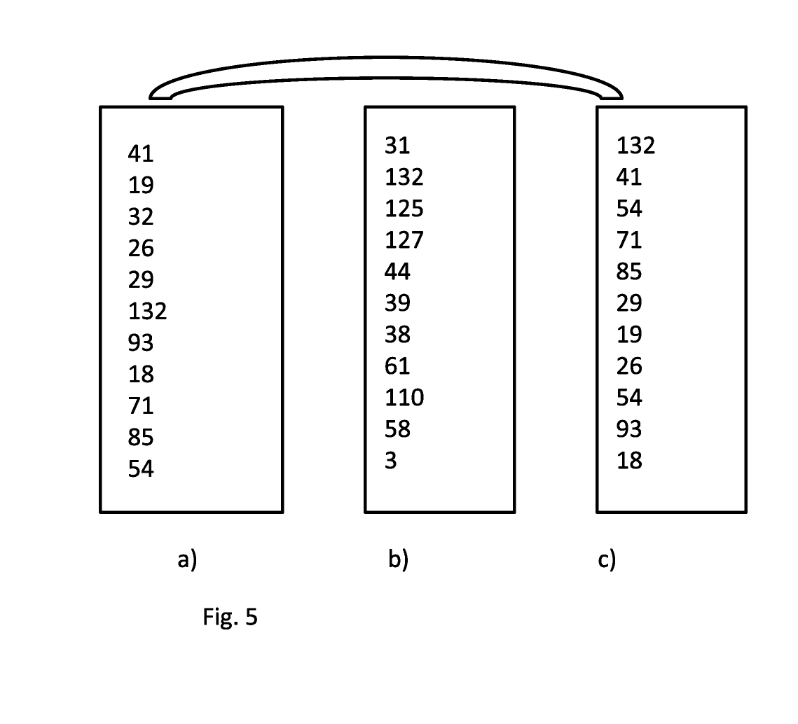

The above calculation does not provide absolute values for user preference but rather relative values compared to the items rated. The relative values can then be used to order the catalog in a vector which is personal to that individual user. Examples of such vectors are given in FIG. 5 which shows the top 18 preferences of three given users in three different vectors, a), b) and c). In FIG. 5, item numbers are ordered according to the preferences of three different users.

The system may then use the vectors to find users having shared interests. In one embodiment the top M slots of the N member vector are examined and the intersection between two users in these top slots is found. A large intersection indicates two users with lots of interests in common. A small intersection indicates users with little in common. In FIG. 5, vectors a) and b) show no intersection in the top eleven slots, and thus end-users a) and b) may be assumed to have little in common. Likewise vectors b) and c) have no intersection and thus the corresponding users may be assumed to have little in common. However vectors a) and c) share all eleven items in the top part of the vector, even though they are in a completely different order and thus users a) and c) can be assumed to have a great deal in common.

Once two users are determined to have interests in common they may be suggested to each other as potential connections, for example as a list of suggested connections, or by sending a mail with suggestions or by sending the relevant user profile.

As discussed above, the ratings of the catalog may simply involve choosing a number of stars. The distance between two items may then be the numerical difference between the two ratings, typically averaged between a number of sources or raters. This may apply both to the initial rating of the catalog and to the rating of subsets by individual end users.

The assigned or guessed user preference for any one of the catalog items not in the subset he/she has rated may be based on a direct or a proportional contribution from each one of the end-user rated subset.

As will be discussed in greater detail below, in one embodiment, the catalog items are initially rated by a group of individuals, referred to below as a focus group. The size of the focus group is typically between 32 and 70 individuals and, as discussed, the distances between the catalog items stored in the memory may be an average of distances between ratings provided by each one of the focus group members. In another embodiment the items in the catalog may be items for which preference data is available from the users themselves. Thus cellular phone application downloads are typically recorded, so that correspondence between pairs of downloads is known. Two cellular phone applications often found to be downloaded together may be assigned a short distance, whereas two applications hardly ever downloaded together may be assigned a large distance.

Depending on the usage and the nature of the embodiment, it may be necessary to add new items to the catalog. All that is needed when a new item is added is to provide ratings for the item from the same source as the ratings for the original items in the catalog. From these ratings, distances can be calculated as before and preferences can then be assigned to end users in exactly the same way as for any other catalog item that the end user has not directly rated.

Referring now to FIG. 3, a memory arrangement of distances between pairs of items of an N item catalog is shown schematically as an N×N matrix. The leading diagonal has values of zero as each item has zero distance to itself. The matrix is thus quadratic to the size of the catalog.

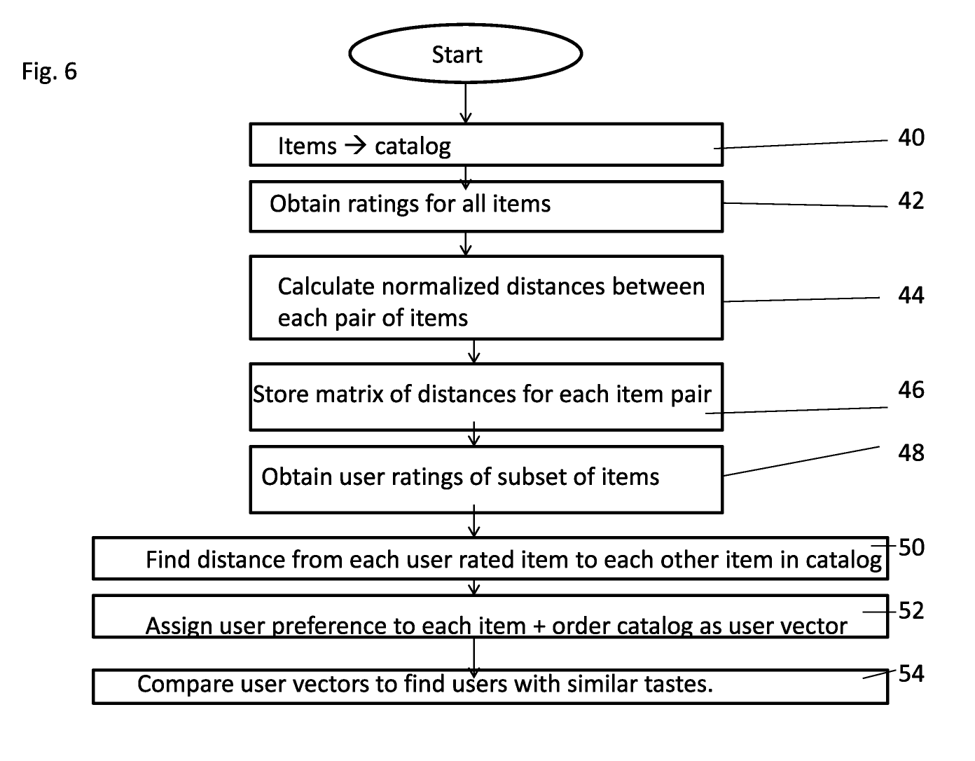

Reference is now made to FIG. 6, which is a simplified flow diagram illustrating the method of some of the present embodiments for estimating preferences of users. In box 40 a closed number of items are formed into a catalog. In box 42, ratings are obtained for each of the items, and in box 44, normalized distances between ratings are obtained. As shown in box 46 the distances may be stored as a matrix with an entry for each pair of items.

At this point the catalog is ready for end users. The different end users are now provided with a small subset of the catalog to rate. The ratings obtained in box 48 are used to along with the stored distances in box 50 to assign the individual user a preference level for each item in the catalog in box 52. The catalog is then ordered into a vector for the individual user and respective user vectors are compared to indicate users with similar tastes.

In greater detail, one may prepare a catalog of items to serve as a test bed for taste and then use a recommendation algorithm on the catalog to determine the preferences of any user on the basis of a small sample of what the user may like and dislike. These items may be easily presented on a computer or the screen of any mobile device: images, movies, musical tracks or video clips, for example. They may typically span many different categories of items: e.g. faces, landscapes, art, architecture, fashion, design, online games, commercial products, foods, different sorts of music and of movies, the more varied the more general is the taste that is found.

The user may then be requested to pick a small number of items from the catalog that he especially likes and a similar number of items he especially dislikes. This may be done in a fun way: the user may glance at items in the catalog and pick those he likes and dislikes on the go. He may have seen only a small part of the catalog. The recommendation algorithm then guesses a list of items from the catalog that he may like, and also, perhaps, a list of items guessed to be disliked. An alternative version would use a recommendation algorithm that guesses the rating, say between 0 and 1, that the present user would give to each of the items in the catalog. Later, the user may be encouraged to pick more items liked and disliked and thus may improve the quality of the recommendations and therefore refine the results of his search for close strangers. He will be able to choose the types of items he is interested in rating: e.g., music, games, houses, shoes etc.

Given any two users who have been subjected to the recommendation algorithm, one can measure their proximity: users who are predicted to like the same items and dislike the same items, i.e., users who would be recommended the same items, are close in taste, users who are predicted to like different items are further apart. The exact measure of proximity used may depend on the format of the results of the recommendation algorithm. If the algorithm computes guesses (between 0 and 1, say), any one of the measures used for evaluating the distance between two real vectors of size n, where n is the number of items in the catalog, can be used, e.g. Euclidean distance. If the algorithm computes a set of items guessed to be liked and a set of items guessed to be disliked, the size of the intersection of the sets of liked items for both users and the size of the intersection of the sets of disliked items can be used.

Once such a proximity index has been computed between a given user and all the other users, or a large set of other users, the closest users may be proposed to the present user as potential close strangers. If the recommendation algorithm succeeds in guessing correctly the items liked and disliked by users, then the proposed close strangers may indeed be close in taste. The recommendation algorithm is therefore selected with care. It is noted that, on one hand, the selected algorithm may work across different types of content: and may be capable of predicting say which sorts of music I like given a sample of my taste in movies, or in landscapes. The present embodiments show that this is indeed possible with good results. Notice also, on the other hand, that the catalog used in determining the taste of users need not be very large: if two persons agree on which items they like and dislike from a catalog of a few hundred items from different realms, one can say they most probably have closely related tastes overall.

### Using the Focus Group Method

The requirement above to use a recommendation algorithm capable of working across different types of content suggests an item-to-item method. In such methods a matrix of distances, or pseudo-distances, between each pair of items is computed: the distance between two items is small if people who like one generally like the other one and people who dislike one generally dislike the other.

Once such a matrix of item-to-item distances has been computed, for a user about whom one knows only a small sample of his taste, one can compute guesses about the grades he would give to each item of the catalog by essentially extrapolating the grades he gave to the small sample of items he rated. Every rated item contributes its grade weighted by some decreasing function of its distance to the item in question.

Different extrapolation methods can be used. Item-to-item methods have rarely been used by themselves in recommendation systems, because they require the storage of a matrix that is quadratic in the size of the catalog. They have been used as an auxiliary method to sharpen the results of collaborative filtering, as described for example in U.S. Pat. No. 6,266,649 “Collaborative recommendations using item-to-item similarity mappings”. The present embodiments however need to deal only with catalogs of limited size and thus the quadratic growth of the algorithm ceases to be a problem, and a pure item-to-item method may therefore be used. U.S. Pat. No. 7,075,000 “System and method for prediction of musical preferences” referred to hereinabove describes different methods for obtaining a suitable item-to-item matrix in the musical domain. One of the methods described there, the Song Map method, probably better called the Focus Group method, is not limited to the musical realm, but directly applicable to catalogs of items taken from different domains and therefore a candidate of choice for the present application. It was already noted in the patent above that this method gives the most accurate recommendations. It has been noticed since then that its extrapolation method gives results that are more accurate than those provided by the item-to-item method used by Amazon.com as described in Greg Linden, Brent Smith, and Jeremy York. Amazon.com recommendations: Item-to-item collaborative filtering. IEEE Internet Computing, 7(1):76 80, January-February 2003, the content of which is hereby incorporated by reference as if fully set forth herein.

A short description of the Focus Group method (Song Map method of the patent above) follows. A group of raters is assembled. Each rater gives a grade to each of the items of the catalog, the grade describing how the item in question fits his taste. For a catalog of limited size, this is a perfectly reasonable task. The grade is given on a finite scale: let's say on a scale of between 2 and 7 values. The group of raters must include people of different backgrounds, sensibility, age and gender but need not be statistically representative of the intended audience. Experience tells us that the number of raters should not fall below 32 and that there is little to gain by using more than about 70 raters. To each rater one associates a vector of n ratings where n is the size of the catalog. The distance between any two items of the catalog is computed by averaging, in some way, the differences in the grades given by all the raters to those two items. Normalization may be used to obtain distances in the interval [0, 1].

Even though the Focus Group method seems to be the method of choice, other methods may be used to compute the matrix of item-to-item distances.

### Measuring the Proximity of Users

Once the opinions of all users have been guessed on every item of the catalog, there are many ways one can evaluate the proximity (or the distance) between any two users. If one has computed a vector of guessed ratings (say in [0, 1]) for each item, one can use any reasonable measure of distance between vectors of n real numbers, for example Euclidean distance. But it may be the case that one does not compute guessed ratings, but is satisfied with only ordering the items of the catalog by guessing which item is preferred to which item. This last information bypasses a delicate normalization that is needed to obtain guessed ratings, and therefore more reliable. In case one computes only this ordering, one can fix a number k of items (say k=0.1×n) and associate with every user the k items he is guessed to prefer over all others. The proximity of two users is then well measured by the size of the intersection of the sets of items associated with both users: the larger this intersection the closer the users.

The present embodiments suggest to users that are found to be close to each other by the measurements disclosed herein to get in touch, since they most probably share common taste. They like and dislike the same items of the catalog, and therefore like and dislike the same things in many realms of life.

### Convincing Users

One of the attractive features of the present embodiments is that the system may be capable of guessing with high accuracy, for a pair of users who have been classified as close in taste, a list of items that both like or both dislike, even in realms about which the users have not indicated any opinion. This provides a solution to an important problem: how to convince users who have been detected as close in taste to initiate a relation? Users may be presented a list of items and find they agree on which of them they like and which they dislike. Users may also be offered a look at the profile of users who are close to them in taste, and a glance at content such as photos, videos and audio content that those users have gathered in social media and networks: YouTube, Facebook, MySpace, Twitter, Pinterest and others.

### Matching Users

The present embodiments may match users who have similar tastes. The means at their disposal for this purpose have essentially been described above:

1. a catalog of varied items that can be picked up as liked or disliked,

2. the capability to obtain a list of users potentially close in taste, to look at their profiles, glance at the content (clips, music, pictures) that they have gathered in different networks, and

3. a message system for socializing with those close strangers.

The system may also support continuing relations between users who have been identified as having similar tastes and have accepted to stay in touch with each other. The system may provide facilities similar to those provided by social networks such as Facebook: wall, messaging, storing content, timeline and so on.

The system may also provide a facility for creating groups or circles of users with similar tastes for chatting and exchanging information and content. Those groups may provide forums limited to persons sharing similar tastes and who, therefore, are naturally close to one another and can rely on one another's advice in matters of taste.

### Analytics

Once a social network has been built on the principles described above and a reasonable number of users has been gathered, the system can use its knowledge of the user's tastes for very effective targeted advertisement. The system can support ads based on likes and dislikes in the way Google supports ads based on keywords. But the system can also provide a completely novel way to obtain analytics, i.e., detailed reliable statistical information on the future appeal of a new product. The new product is presented to the Focus Group responsible for building the matrix of item-to-item distances. This is a small group and the cost of having an item presented to and rated by the group is low. The Focus Group does not need to be statistically representative of the target population. One can then compute the distances between the new item and each of the items in the catalog. The recommendation system can now compute, for every user, whether the user is estimated to like or dislike the new item. Note that there is no need to request or to wait for the reactions of the users to the new product, all that is needed is a computation. The set of users who are predicted to like the product can now be analyzed using the users' profile information to determine the type of persons who are susceptible to the new product.

### Targeted Advertisement without a Social Network

In a different environment, the ideas above may also be applied to targeted advertisement without a social network. If information about a user's likes and dislikes of items in the catalog can be gathered without requiring him to actively manifest his taste, then the methods described above can be applied to effectively target advertisements. The apps (mobile applications) market seems very promising in this respect. When a user connects to an app store and decides to download an application, the company providing the software for performing the download has access to the list of apps stored in the user's smart phone and also to some information about the history of downloads, usage and deletions of apps from this smart phone by this user. Once a catalog of the most popular apps has been gathered, the information available may be used to indicate which apps in the catalog the user likes and which ones he dislikes. The methods above then allow the computation of a list of users close in taste to the user in question. The system may then present advertisements for apps liked by the users that are close in taste to our user. This will provide for very effective targeting.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment, and the above description is to be construed as if this combination were explicitly written. Conversely, various features of the invention, which are, for brevity, described in the context of a single embodiment, may also be provided separately or in any suitable subcombination or as suitable in any other described embodiment of the invention, and the above description is to be construed as if these separate embodiments were explicitly written. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A system for estimating preferences of users implemented using a plurality of electronic processors connected over a network, the system comprising:
a catalog having a closed number of items;
a memory for storing distances between ratings of each pair of said items;
a user interface configured to provide a first user over said network with a subset of said closed number of items, and to obtain ratings from said user for said subset;
one of said processors configured to use respective stored distances from said subset to other items of said catalog to assign to said first user a preference for items of said catalog other than those belonging to said subset;
the system further configured to use said assigned preferences for said first user to therewith associate said first user with other users having similar preferences by finding ones of said other users whose respective assigned preferences are close to said assigned preferences of said first user.

2. The system of claim 1, wherein for each of said users, said items in said catalog are ordered according to said assigned preferences into a vector.

3. The system of claim 1, wherein said assigned user preference for any one of said items not in said subset comprises a proportional contribution from each one of said subset of items.

4. The system of claim 1, wherein said catalog items are rated by a first plurality of individuals, and said distances comprise an average of distances between ratings provided by each one of said first plurality of individuals.

5. The system of claim 2, configured to compare respective vectors based on a number of common items appearing in top M items of said respective vectors, wherein M is a predetermined number.

6. The system of claim 1, further configured to send to said respective user, profile information of said others users associated by similar preferences.

7. The system of claim 1, wherein said ratings are numerical and said distances comprise a numerical difference between said numerical ratings of respective pairs of items.

8. The system of claim 1, further configured to add an item to said catalog, said item being added along with ratings so that distances are computable to each other item in said catalog, a preference to each user thereby being obtainable.

9. The system of claim 1, wherein the distances between each pair of items are stored in a matrix, said matrix being quadratic to a size of said catalog.

10. The system of claim 1, wherein said first plurality lies between 32 and 70.

11. The system of claim 1, wherein said items are downloadable device applications and said distances are obtained from data of applications held simultaneously by individual devices.

12. A method for estimating preferences of users implemented using a plurality of electronic processors connected over a network, the method comprising:
providing a catalog having a closed number of items;
storing distances between ratings of each pair of items;
providing a user over said network with a subset of said closed number of items;
obtaining ratings from said user for said subset;
using respective stored distances from said subset to other items of said catalog to assign to said user a preference for items of said catalog other than those belonging to said subset; and
using said assigned preferences for a respective user to order all items in said catalog to form a vector for said user, therewith to associate said user with other users having similar preferences by finding other users having similar vectors.

13. The method of claim 12, wherein said distances are, for each pair of items a difference in respective ratings.

14. The method of claim 12, wherein said assigned user preference for any one of said items not in said subset comprises a proportional contribution from each one of said subset of items.

15. The method of claim 12, comprising rating said items using a first plurality of individuals, a difference between each pair of items being an average of differences between ratings of each one of said plurality of individuals.

16. The method of claim 12, comprising comparing respective vectors based on a number of common items appearing in top M items of said respective vectors, wherein M is a predetermined number.

17. The method of claim 12, comprising sending to said respective user, profile information of said others users associated by similar preferences.

18. The method of claim 12, wherein said ratings are numerical and said distances comprise a numerical difference between said numerical ratings of respective pairs of items.

19. The method of claim 12, comprising subsequently:
adding a further item to said catalog;
rating said item;
calculating distances to each other item in said catalog; and
obtaining preferences for each user who has rated a subset.

20. The method of claim 12, comprising storing the distances between each pair of items in a matrix, said matrix being quadratic to a size of said catalog.

21. The method of claim 12, wherein said first plurality lies between 32 and 70.

22. The method of claim 12, comprising storing the distances between each pair of items in a matrix, said matrix being quadratic to a size of said catalog.

23. The method of claim 12, wherein said first plurality lies between 32 and 70.

24. The method of claim 12, wherein said items are downloadable device applications and said distances are obtained from data of applications held simultaneously by individual devices.

25. A method for estimating preferences of users implemented using a plurality of electronic processors connected over a network, the method comprising:
providing a catalog having a closed number of items;
storing distances between ratings of each pair of items;
providing a first user over said network with a subset of said closed number of items;
obtaining ratings from said first user for said subset;
using respective stored distances from said subset to other items of said catalog to assign to said first user a preference for items of said catalog other than those belonging to said subset;
finding a distance using a distance measure between preferences of said first user over said catalog and preferences of a second user; and
associating said user with said second user if said distance is relatively small.

26. A user client for use with the system of claim 1.
